(19) United States
(12) Patent Application Publication
(10) Pub. No.: US 2013/0030991 A1
(43) Pub. Date: Jan. 31, 2013

(54) TELECOMMUNICATIONS INITIATED PAY PER CHARGE SYSTEM

(71) Applicants: Donald Robert NEIDLINGER, Grand Haven, MI (US); Shawn Ray GIBSON, Fremont, MI (US)

(72) Inventors: Donald Robert NEIDLINGER, Grand Haven, MI (US); Shawn Ray GIBSON, Fremont, MI (US)

(73) Assignee: RAM ELECTRONICS, Fruitport, MI (US)

(21) Appl. No.: 13/558,065

(22) Filed: Jul. 25, 2012

Related U.S. Application Data
(60) Provisional application No. 61/511,276, filed on Jul. 25, 2011.

(51) Int. Cl. H02J 7/00; G06Q 20/22

(52) U.S. Cl. 705/39; 320/114

(57) ABSTRACT

A system and method for recharging a battery of a mobile device for a fee authorized by a financial account control server can include a battery recharging station having at least one recharging connection for a mobile device. The battery recharging station can be in communication with an electronic data connection for selective activation and deactivation of power supplied to the at least one recharging connection for recharging a battery of a mobile device. A recharging service control server can be operable to remotely control activation and deactivation of power supplied to the at least one recharging connection located at the battery recharging station through the electronic data connection in response to receipt of communication from the financial account control server regarding validation and acceptance of payment by a user of the battery recharging station.

### CROSS-REFERENCE TO RELATED APPLICATIONS

This application claims the benefit of U.S. Provisional Patent Application Ser. No. 61/511,276 filed on Jul. 25, 2011, which is incorporated by reference herein in its entirety.

### FIELD OF THE INVENTION

The invention relates to a system including a station for recharging a battery of a mobile device, such as a mobile phone, computer, digital camera, or the like, and more particularly a system capable of collecting payment for the recharging service provided through electronic commerce transactions.

### BACKGROUND

Mobile equipment, such as cell phones, computers, cameras and the like, current lack sufficient battery capacity to continue operation of the device for an extended period of time without recharging. People are commonly faced with the difficultly of locating an electrical outlet to recharge mobile equipment while traveling through airports, train or subway stations, bus terminals and the like. It would be desirable to provide a fixed recharging station, such as a kiosk or the like, where customers could easily recharge mobile equipment for a nominal cost. It would be desirable to provide a convenient recharging station capable of simplified electronic commerce transactions to collect a nominal fee for recharging mobile equipment.

### SUMMARY

A system is disclosed including a method and hardware that can provide a pay for charge service to the user. As implemented in hardware, this system would provide from single to multiple charging stations each with a unique ID or PIN number. The user would be presented either/or a charging receptacle or USB A type connector, or any other current state of the art charging outlet. The outlet and/or charging receptacle is controlled by a server that is accessed and controlled from a remote center or location. The remote center communicates with the server by means of a communication network that may include internet, satellite, telephone or wireless technology. To use the pay for charge service, the user dials a phone number provided at the charging location. Then enters the unique ID or PIN number to be used for recharging the mobile device. The remote center would then charge the users account (typically his/her telephone account). When payment is secured, the remote center would access the server and cause the charging receptacle and/or USB charging outlet to be activated. The user would be alerted that the charge was available by means of an audible and/or visual indicator (possibly on the user's mobile device). The charge can be terminated after a pre-determined amount of time, charge or when the device to be charged is removed from the receptacle or USB charging connector.

A user can access a central server via current technology of the day, (cell phone, satellite, IP address, wifi). The user or user's device would indicate the power outlet or charge delivery device to be used for charging. The server would access the user's account to validate funds. The server would access the outlet and turn the charging outlet on via technology of the day (i.e. internet access with IP address). The outlet would report back to the server when the charge was complete. The server would then charge the user's account: a proportional rate based on amount of power, a fixed rate per unit of time (i.e. $0.10 per minute), or a fixed dollar amount (i.e. $1.00 per charge).

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic diagram illustrating a telecommunications pay per charge system according to the present invention; and

FIG. 2 is a simplified flow diagram illustrating operation of the telecommunications pay per charge system of FIG. 1.

### DETAILED DESCRIPTION

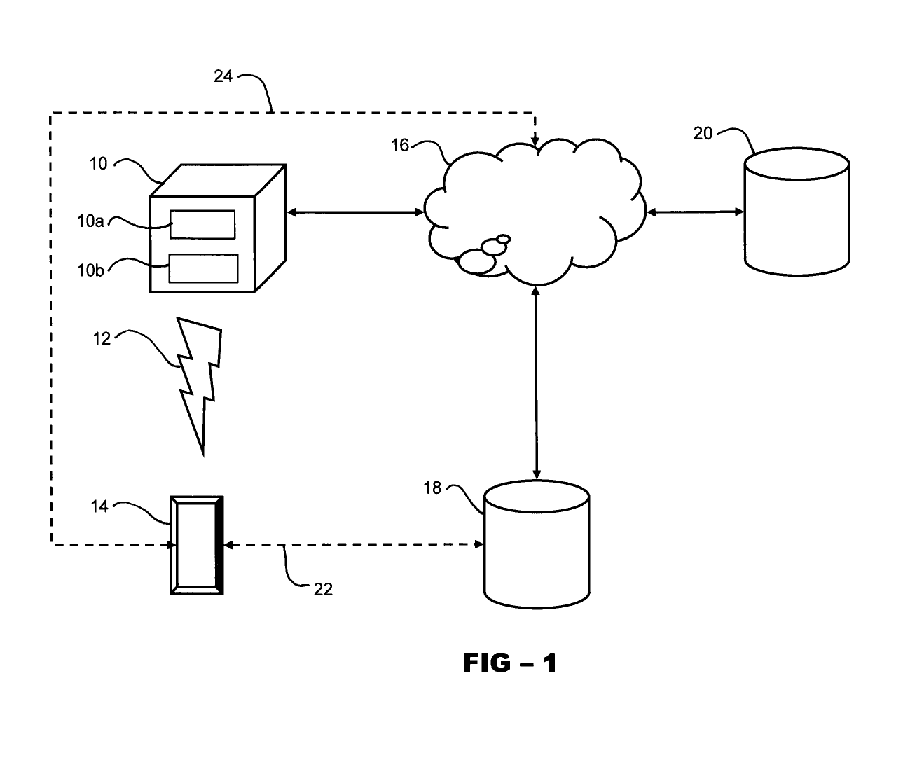

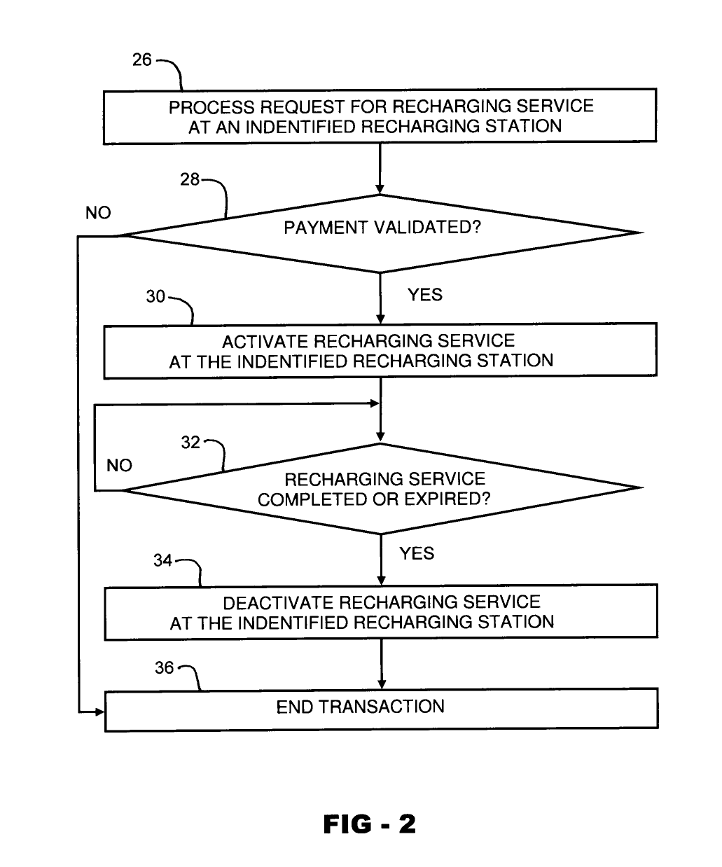

Referring now to FIG. 1, a system is schematically illustrated for providing pre-paid access to a battery recharging station 10 having at least one recharging connection 12, by way of example and not limitation, such as a recharging cord, plug, or receptacle. Each recharging connection 12 having unique identification indicia, by way of example and not limitation, such as a number, bar code, or graphic code. The battery recharging station 10 for recharging a battery of a mobile device 14 is operable through an electronic data connection 16, by way of example and not limitation, such as through an internet connection or network connection in communication with a recharging service control server 18. The recharging service control server 18 communicates with a billing system control server 20, by way of example and not limitation, such as of a telephone service provider network or alternate pre-pay account. Referring now to FIGS. 1 and 2, a request for recharging service can be established for access to a battery recharging station 10 using a telephone billing control server 20 of a telephone network service provider through either a user initiated telephone call 22 or user initiated internet data connection 24 to pre-pay for battery recharging services at a specific battery recharging station 10 location. Alternatively, a user can choose to pre-pay for battery recharging service by means of selecting, through either a menu or mobile device application, to pay by billing control server 20 of an alternative financial account.

In either case, the recharging service control server 18 can receive an incoming call 22 or data connection 24 from a mobile device 14 of a user at a communications connection serving a battery recharging station provider telephone number. This begins step 26 of FIG. 2, where processing of a request for battery recharging service at an identified recharging station is initiated by the recharging service control server 18. The calling party telephone number or internet protocol number (IP number) can be stored in a user identification field associated with the incoming call 22, or data connection 24. Additionally, a unique identification indicia, by way of example and not limitation, such as an ID or PIN number of the at least one recharging connection 12 at a particular batter recharging station 10 location can be requested of, and/or provided by, the user and retained with the request for battery recharging service.

The battery recharging station control server 20 can send a query from the switch to a database of the billing control server 20 of the telephone service provider network, or alternative pre-pay financial account 20 in response to the user initiated request. The query can include a calling party telephone number, or IP number, and unique identification indicia, such as an ID or PIN number of a specific battery recharging location 10 and specific recharging connection 12. A response to the query can be provided by the billing control server 20, with a pre-determined code indicating that the pre-paid transaction has been validated and accepted either by the billing control server 20 of the telephone service provider network, or the alternative financial account.

If validation and acceptance of the electronic transaction fails in step 28, the request for battery recharging services transaction is terminated in step 36, ending the call, or data connection, by the requesting party with an indication of payment failure, when the pre-determined code indicating payment acceptance is not received from the billing control server 20. If validation and acceptance of the electronic transaction is successful in step 28, the battery recharging service control server 18 continues to step 30 by activating power supply to the uniquely identified recharging connection 12 of the battery recharging station 10 location as indicated by the unique identification indicia, such as an ID or PIN number, using remote access via the electronic data connection 16. By way of example and not limitation, the electronic data connection 16 can be an internet data connection, or an intranet data connection, or network data connection. In any case, the data connection 16 can be either a wired data connection or a wireless data connection.

In step 32, the battery recharging service control server 18 determines if the battery recharging service has been completed or expired. If the battery recharging service is not completed or expired, the battery recharging service control server 18 continues to loop through step 32, which maintains the battery recharging service for the identified recharging connection 12 at the specific battery recharging station 10 location in an active state until the charge is terminated at a pre-determined amount of charge time or charge amount (Amp-Hours). When the battery recharging service is completed or expired, the battery recharging service control server 18 continues to step 34, which de-activates the battery recharging service for the identified recharging connection 12 at the specific battery recharging station 10 location. Step 32 can also determine when the mobile device 14 has been disconnected or removed from the battery recharging station 10 location and deactivates the battery recharging service at the specific battery recharging station 10 in response.

After deactivation of the battery recharging services at the specific identified battery recharging station 10, the battery recharging service control server 18 continues to step 36 and ends the requested battery recharging transaction. The battery recharging service control server 18 then returns to step 26 to process the next incoming request for battery recharging service.

The battery recharging station 10 location can be identified by means of a unique ID or PIN number along with a telephone number to be dialed for activation of the battery recharging service clearly marked on the battery recharging station 10. A permanently affixed tag or marker can be applied to the battery recharging station 10 location as an option for clearly marking the location with the information required to activate the service.

The use of a computer program commonly known as an application (App) on a mobile device, by way of example and not limitation, such as a bar code or graphic code scanner, or GPS locator, or a biometric scanner can be used to provide the information required to associate the location and identity of the user when pre-paying by use of the billing control server 20 of a telephone service provider network, or alternative financial account. Alternatively, the system can use a computer-readable medium containing computer-readable program code (commonly known as an App) that, when executed on a mobile device, causes the mobile device to deduct a fixed amount of money from a financial account directed by the mobile device operator, the deducted amount then being credited to the charging station providers account. The system optionally can access a financial account of a user based on identification data for the user, deduct a battery recharging fee amount from the financial account of the user, and credit the deducted battery recharging fee amount to a financial account of a battery recharging station provider. The identification data of the user, by way of example and not limitation, can include a biometric scan, a telephone number, credit card data obtained through a credit card reader, a user input identification number, and/or an authorization code.

The acknowledgement of the transfer of funds determined by step 28, as well as the desired battery recharging station 10 location and recharging connection 12 to be activated, can be communicated to the battery recharging control server 18 by means of a data communication connection 16, such as an intranet connection or an internet connection. The acknowledgement of the transfer of funds can include the steps of accessing the financial account of the caller in a telephone billing control server of the telephone service provider network based on the caller's telephone number, deducting a fixed amount from a pre-paid account, or debiting a fixed amount from the caller's account, the deducted amount then being credited to a financial account associated with the battery recharging station 10 provider.

A text or voice prompt can be sent to the caller to obtain the desired unique ID or PIN number associated with the battery recharging station 10 and recharging connection 12 to be activated. The use of a text or voice prompt can be used, when required by statute, to authorize the telephone billing control server 20 of the telephone service provider network to access the callers account for payment. The accessing of a database of the telephone billing control server 20 of the telephone service provider network, or alternative pre-pay financial account control server 20, can be accomplished by means of a wired or wireless data connection 16. The calling party number and unique ID or PIN number associated with the battery recharging station 10 location can be provided on the itemized bill or receipt of the accessed account for tracking purposes.

A wired or wireless data network can be used to transfer a unique pre-determined code between the billing control server 20 and the battery recharging service control server 18. The pre-determined code can include either a positive or negative response indicating the success or failure of the pre-payment transaction in step 28 respectively. The available mobile device features, that are accessible by the telephone data/voice network, can be used to inform the caller of the transaction success or failure in step 30 or step 36 respectively. The available features of the battery recharging station 10, that are accessible by the battery recharging service control server 18 through the data connection 16, can be used to inform the caller of the payment transaction success or payment transaction failure in step 30 or step 36 respectively. In other words, a telecommunications, either voice or data, initiated battery recharging cycle can be deliverable through the battery recharging station 10 to a user.

By way of example and not limitation, a display panel or screen 10a and data input device 10b, or interactive touch screen, can be provided on the battery recharging station to allow a user to access the system and to receive prompts, communications, or feedback regarding the status, success or failure, of the transaction requested. Alternatively, a light emitting diode (LED) device embedded into the battery recharging station 10, and accessible by the battery recharging service control server 18 through the data connection 16, can be used to indicate failure of the financial transaction by flashing at a rate indicative of the failed state. A speaker, piezo, or sound emitting device embedded within the battery recharging station 10, and accessible by the battery recharging service control server 18, through the data connection 16 can be used to indicate failure of the financial transaction by generating a tone or tones indicative of the failed state. Internal features of the mobile device 14, which can be initiated to indicate a failed financial transaction, can include a primary screen, a secondary screen, and a built in speaker, vibratory devices and/or any built in enunciators.

A wired or wireless data network can be used to signal a computer/microprocessor controlled switch by the battery recharging service control server 18, allowing the current and voltage to be activated at the desired battery recharging station 10 location and identified recharging connection 12 for recharging a batter of a mobile device 14. Either an electromechanical switching device, or semi conducting switching device, can be used for the purpose of activating the charging current and voltage. A light emitting diode (LED) device can be activated in parallel with the charging voltage to indicate the successful activation of the battery recharging circuit. In other words, the light emitting diode (LED) device can be seen by the caller as an indication that the battery recharging station 10 and identified recharging connection 12 has been activated and is being supplied with power. Optionally, a speaker or sound emitting device can be activated in parallel with the initial charging voltage to signal to the caller that the battery recharging station 10 and identified recharging connection 12 has been activated and is being supplied with power. Circuitry can be embedded within the battery recharging station 10 to limit the power delivered by the battery recharging station through the identified recharging connection 12 to a safe and pre-determined amount.

It should be understood that the telephone connection, or data connection, with the battery recharging service requester used to initiate the request for battery recharging service can be terminated in response to a successful activation of the desired battery recharging station 10 and identified recharging connection 12.

A computer or microprocessor based computer code can be used to maintain and implement a timer for the purpose of determining the amount of time the battery recharging station 10 and identified recharging connection 12 has been active. The timer can be used to trigger a signal to the switching device to terminate power being supplied to the battery recharging station 10 and identified recharging connection 12 when a pre-determined amount of activation time has occurred. Optionally, a computer or microprocessor and computer code can be used to maintain and implement an accumulator register for the purpose of determining the amount of charge that has been delivered to the battery recharging station 10 and identified recharging connection 12 during a battery recharging service cycle. A current measuring circuit or module and a timekeeping device, module or register can be used to accumulate the amount of charge in Amp-Hours or some direct conversion of Amp-Hours. The product of the current and time can be summed and accumulated in a register as Amp-Hours by using sufficiently small units of time and a direct reading of the current being delivered at the instant the time is recorded. The active status of the charging station can be optionally terminated when a pre-determined amount of Amp-Hours have been accumulated in the register. In other words, the battery recharging station 10 can monitor at least one of a timer corresponding to a battery recharging service cycle and a current measuring circuit to accumulate a value corresponding to an amount of charge in amp-hours delivered during a battery recharging service cycle at the battery recharging station 10.

The battery recharging station 10 and identified recharging connection 12 current can be monitored for detecting a removal of the recharging mobile device by a change of current delivered to the mobile device being recharged from some pre-determined charge rate to a charge rate of zero. Optionally, the battery recharging station 10 and identified recharging connection 12 can be monitored for removal of a mobile device being charged by a secondary switch or proximity device using inductance, capacitance and/or light to detect a presence or absence of a mobile device to be charged. The source of current and voltage from the delivery port of the battery recharging station 10 and identified recharging connection 12 can be disabled and removed to leave the recharging connection 12, such as a cord, plug, or receptacle 12, of the battery recharging station 10 in an un-powered or deactivated state until the next request for battery recharging service at that particular battery recharging station 10 and identified recharging connection 12.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A system for recharging a battery of a mobile device for a fee authorized by a financial account control server comprising:
a battery recharging station having at least one recharging connection for a mobile device, the battery recharging station in communication with an electronic data connection for selective activation and deactivation of power supplied to the at least one recharging connection for recharging a battery of a mobile device; and
a recharging service control server operable to remotely control activation and deactivation of power supplied to the at least one recharging connection located at the battery recharging station through the electronic data connection in response to receipt of communication from a financial account control server regarding validation and acceptance of payment by a user of the battery recharging station.

2. The system of claim 1 further comprising:
a telecommunications initiated battery recharging service cycle deliverable through the battery recharging station.

3. The system of claim 1 further comprising:
a unique identification indicia associated with each one of the at least one recharging connection of the battery recharging station.

4. The system of claim 1 further comprising:
a telephone number associated with the battery recharging station, wherein the user initiates a request for battery recharging service by calling the telephone number.

5. The system of claim 1 further comprising:
a unique identification indicia associated with each one of the at least one recharging connection of the battery recharging station, wherein the user identifies the recharging connection to be activated by the unique identification indicia associated with the recharging connection.

6. The system of claim 1 further comprising:
a unique identification indicia associated with the battery recharging station, wherein the user initiates a request for battery recharging services by the electronic data connection.

7. The system of claim 1 further comprising:
a display panel and data input device associated with the battery recharging station, wherein the user initiates a request for battery recharging service at the battery recharging station.

8. The system of claim 1 further comprising:
accessing a financial account of a user based on identification data for the user, deducting a battery recharging fee amount from the financial account of the user, the deducted battery recharging fee amount then being credited to a financial account of a battery recharging station provider.

9. The system of claim 1 further comprising:
a computer-readable medium containing computer-readable program code that, when executed on a mobile device, causes the mobile device to deduct a fixed amount of money from a financial account directed by the user of the mobile device, the deducted fixed amount of money then being credited to a financial account of a battery charging station provider.

10. The system of claim 1 further comprising:
a computer-readable medium containing computer-readable program code, that when executed by the battery recharging station, cause the battery recharging station to monitor at least one of a timer corresponding to a battery recharging service cycle and a current measuring circuit to accumulate a value corresponding to an amount of charge in amp-hours delivered during a battery recharging service cycle at the battery recharging station.

11. A method for recharging a battery of a mobile device for a fee authorized by a financial account control server comprising:
processing a request for battery recharging service at a battery recharging station initiated by a user;
determining if a payment transaction from the user has been accepted by a financial account control server through an electronic data connection;
if the payment transaction has not been accepted by the financial account control server, terminating the request for battery charging service;
if the payment transaction has been accepted by the financial account control server, activating power to be supplied through at least one recharging connection at the battery recharging station for providing a battery recharging service cycle;
monitoring if a battery recharging service cycle has been completed;
if the battery recharging service cycle has not been completed, continuing the monitoring step; and
if the battery recharging service cycle has been completed, deactivating power supplied through the recharging connection at the battery recharging station.

12. The method of claim 11 further comprising:
associating a unique identification indicia with each one of the at least one recharging connection of the battery recharging station, wherein the user identifies the recharging connection to be activated by the unique identification indicia associated with the recharging connection.

13. The method of claim 11 further comprising:
associating a telephone number with the battery recharging station, wherein the user initiates the request for battery recharging service by calling the telephone number.

14. The method of claim 11 further comprising:
associating a unique identification indicia with the battery recharging station, wherein the user initiates the request for battery recharging services by the electronic data connection.

15. The method of claim 11 further comprising:
associating a display panel and data input device with the battery recharging station, wherein the user initiates the request for battery recharging service at the battery recharging station.

16. The method of claim 11 further comprising:
accessing a financial account of a user based on identification data for the user;
deducting a battery recharging fee amount from the financial account of the user; and
crediting the deducted battery recharging fee amount to a financial account of a battery recharging station provider.

17. The method of claim 11 further comprising:
executing a computer-readable program code stored on a computer-readable medium with a mobile device that causes the mobile device to deduct a fixed amount of money from a financial account directed by user of the mobile device, the deducted fixed amount of money then being credited to a financial account of a battery charging station provider.

18. The method of claim 11 further comprising:
executing a computer-readable program stored on a computer-readable medium that causes the battery recharging station to monitor at least one of a timer corresponding to a battery recharging service cycle and a current measuring circuit to accumulate a value corresponding to an amount of charge in amp-hours delivered during a battery recharging service cycle at the battery recharging station.

19. The method of claim 11 further comprising:
if the payment transaction has not been accepted by the financial account control server, informing the user of a payment transaction failure.

20. The method of claim 11 further comprising:
monitoring a current supplied by the battery recharging station to the at least one recharging connection; and
detecting a removal of the mobile device being recharged by a change in a rate of current delivered to the mobile device from a predetermined rate to a zero rate.
